(19) United States
(12) Patent Application Publication
(10) Pub. No.: US 2021/0019360 A1
(43) Pub. Date: Jan. 21, 2021

(54) CROWDSOURCING-BASED STRUCTURE DATA/KNOWLEDGE EXTRACTION

(71) Applicant: Microsoft Technology Licensing, LLC, Redmond, WA (US)

(72) Inventors: Ziliu LI, Bellevue, WA (US); Junaid AHMED, Bellevue, WA (US)

(73) Assignee: Microsoft Technology Licensing, LLC, Redmond, WA (US)

(21) Appl. No.: 16/514,217

(22) Filed: Jul. 17, 2019

(51) Int. Cl. G06F 16/958; G06F 17/24

(52) U.S. Cl. CPC G06F 16/986; H04L 67/02; G06F 17/241

(57) ABSTRACT

Aspects herein comprise a browser application (for example, an extension) that allows an end user to provide annotated web content to an extraction service. A client-side user can execute the application to select and annotate the data on a web page, and the annotation can indicate a location of and an identification of the kind of data that is in the web page. Then, based on the annotated web pages, one or more template(s)/rule(s) can be developed for the web page. The templates/rules can then be analyzed to extract automatically the structure data for the web page, which can be provided to the user. The template(s)/rule(s) can be uploaded to an extraction service, which collects and manages the template(s)/rule(s). Then, the extraction service can send extracted structure data to end users or other applications.

### BACKGROUND

Some applications, for example, search services can use the structure of a document to help in providing results. Unfortunately, some web documents often do not contain structure information. Web documents are usually unstructured or semi-structured, search engine or web knowledge usually need to extract the structure info from the web documents. For example the product info, book info, etc.

### SUMMARY

Configurations herein comprise a client-side application (for example, a browser plug-in, an extension, etc.) in the browser for the end user to provide the extraction service with annotated web content. Users execute the application to select and annotate the data on a web page. An annotation can indicate what kind of data is annotated and other information. The application output may then be provided into a template service to generate the templates or rules from the annotated web content. Then, based on the template(s)/rule(s), an extraction service can automatically extract the structure data, which may be provided to other applications or users. The template(s)/rule(s) can be uploaded to the extraction service, which can collect and manage the template(s)/rule(s). Then, the extraction service can provide a free service to the end user(s) to extract structure data for a web pages.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates a first system diagram in accordance with aspects of the present disclosure;

FIG. 2A illustrates a block diagram of a extraction service in accordance with aspects of the present disclosure;

FIG. 2B illustrates another block diagram of a client in accordance with aspects of the present disclosure;

FIG. 3 illustrates a signaling diagram between an extraction service and a client in accordance with aspects of the present disclosure;

FIG. 4A illustrates a data structure representing data or signals sent, retrieved, or stored by a virtual assistant in accordance with aspects of the present disclosure;

FIG. 4B is another data structure representing data or signals sent, retrieved, or stored by a virtual assistant in accordance with aspects of the present disclosure;

FIG. 4C is another data structure representing data or signals sent, retrieved, or stored by a virtual assistant in accordance with aspects of the present disclosure;

FIG. 5A illustrates a visual representation of web document being annotated by a client in accordance with aspects of the present disclosure;

FIG. 5B illustrates a visual representation of web document being annotated by a client in accordance with aspects of the present disclosure;

FIG. 5C illustrates a visual representation of web document being annotated by a client in accordance with aspects of the present disclosure;

FIG. 5D illustrates a visual representation of web document being annotated by a client in accordance with aspects of the present disclosure;

FIG. 6 illustrates a method, conducted by a client, for annotating web content in accordance with aspects of the present disclosure;

FIG. 7 illustrates a method, conducted by an extraction service, for generating template(s)/rule(s) based on the annotated web document in accordance with aspects of the present disclosure;

FIG. 8 illustrates a method, conducted by an extraction service, for generating a knowledge graph based on the template(s)/rule(s) in accordance with aspects of the present disclosure;

FIG. 9 illustrates a method, conducted by an extraction service, for building an ontology in accordance with aspects of the present disclosure;

FIG. 10 is a block diagram illustrating example physical components of a computing device with which aspects of the disclosure may be practiced;

FIG. 11A is a simplified block diagram of a computing device with which aspects of the present disclosure may be practiced;

FIG. 11B is another are simplified block diagram of a mobile computing device with which aspects of the present disclosure may be practiced;

FIG. 12 is a simplified block diagram of a distributed computing system in which aspects of the present disclosure may be practiced; and

FIG. 13 illustrates a tablet computing device for executing one or more aspects of the present disclosure.

In the appended drawings, like numerals represent like components or elements.

### DETAILED DESCRIPTION

Aspects herein comprise a client-side application that allows an end user to provide annotated web content to an extraction service. A client-side user can execute the application to select and annotate the data on a web page, and the annotation can indicate a location of and an identification of the kind of data that is in the web page. Then, based on the annotated web pages, one or more template(s)/rule(s) can be developed for the web page. The templates/rules can then be analyzed to extract automatically the structure data for the web page, which can be provided to the user. The template(s)/rule(s) can be uploaded to an extraction service, which collects and manages the template(s)/rule(s). Then, the extraction service can send the extracted structure data to end users or other applications.

The template(s)/rule(s) can be created by different users and might be slightly different from each other. At the server side, a conflation manager can conflate the different templates and provide a consolidated or “best” template/rule. With the shared templates, new users need not select a web content to annotate but can receive an existing template to create new templates/rules to get the structured data from the web page. The users can search and select templates as needed.

The extraction service may comprise several basic components. First, a templates/rules collector can function as an entry point to collect the templates/rules metadata from the end users. A templates/rules validator can validate the metadata and/or the templates/rules. A templates/rules ranking/scorer can then judge the quality of different templates/rules, which may be variable. In at least some configurations, there may be a large set of templates for a web page or website, and the scorer module can rank the templates and/or pick the high-quality templates. This ensures that after conflation or building the graph, the extraction service provides a high-quality output.

A templates/rules conflation can conflate different templates/rules for a web page to extract the same knowledge, which may be organized differently. The templates/rules conflation module can conflate template information or even combine template information into more comprehensive templates. The output of the templates/rules conflation can be provided to a templates/rules knowledge graph builder. A templates/rules knowledge graph builder can manage a group of templates for a web page or website to extract different kinds of knowledge. The templates/rules knowledge graph builder may build the knowledge graph for the website.

A templates/rules serving module can fetch a template for a user to extract more information from other similar pages. This templates/rules serving service can function as an interface for the user to fetch whatever template the user wants and apply the fetched template to the new pages/website. Also, some users can fetch publically-shared templates and use them directly. The template sharing and template transfers enable end users to apply the same templates to different website/pages without creating a new template.

A structural data extraction service can extract structural data from a larger dataset of templates, for example, for several websites. The structure data may then be provided to clients as an extension in the browser. Further, the extension can allow for the user to extract the structural data at the client side rather than in the server. Thus, the users can extract structure information offline or keep the sensitive extraction/template as a local copy only.

The extraction service can leverage the rules to build a super-intelligent model, which can extract automatically structured text from new pages. This model helps to realize the power of converting text to knowledge. Generally, pages from the same website have a similar layout or structure, which provides the opportunity to extract automatically the structure information. Other existing solutions depend on the template to extract the information about the web page. The template, in the other solutions, heavily depends on the quality and quantity of the human labels. Thus, existing solutions are not scaled well and may only focus on the certain websites/pages only.

The aspects herein leverages a crowdsourcing-based solution to resolve the scale out problem for extracting the structural data from web documents. Also, the crowdsourcing-generated templates also could be shared by the end users. The server side can also automatically conflate the new templates and build a knowledge graph base on the template knowledge.

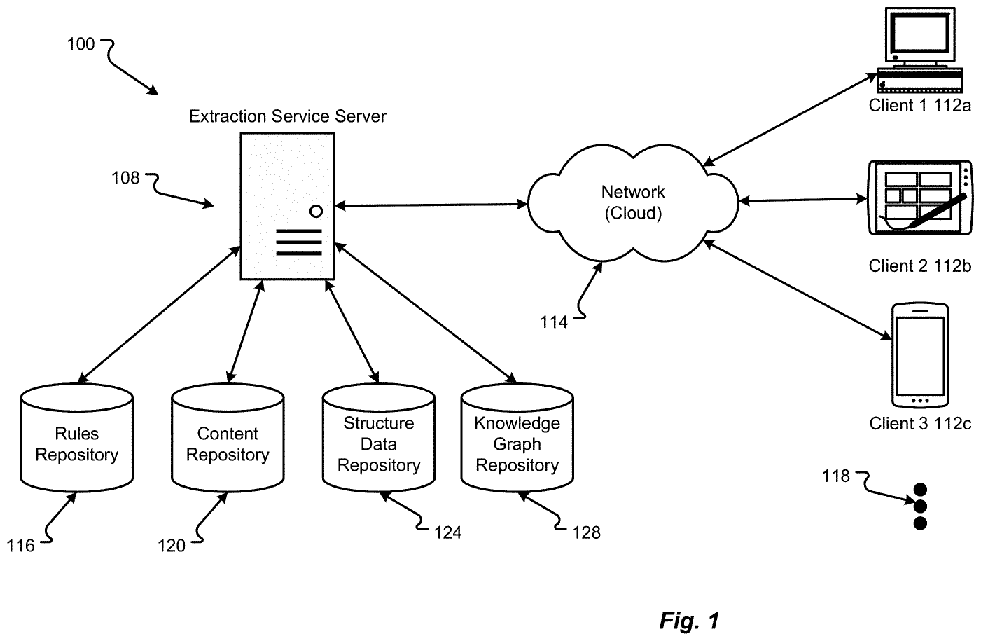

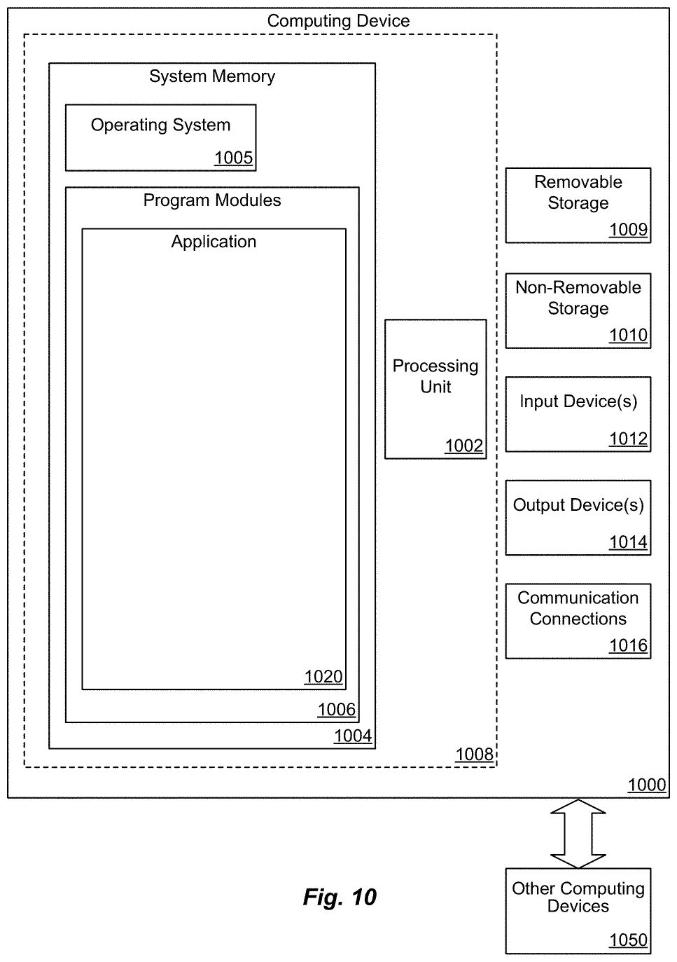

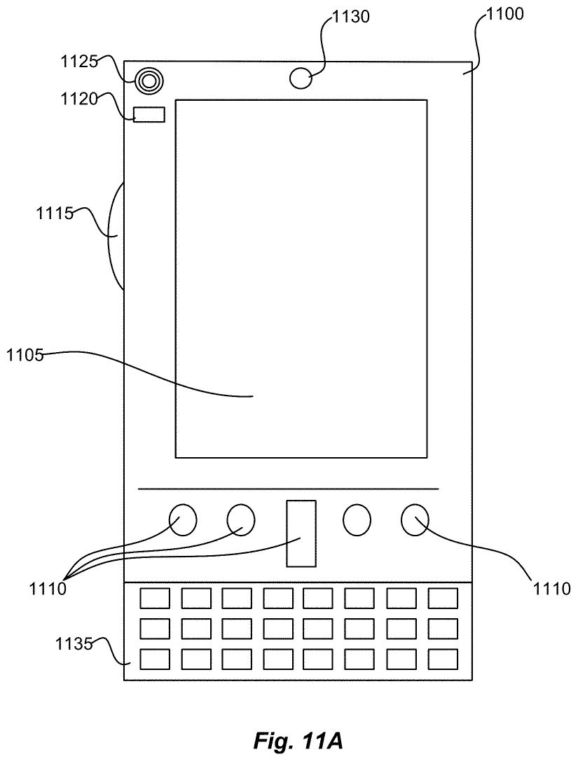

A system 100 for determining attributes about a web document and/or a web site or domain may be as shown in FIG. 1. An extraction service server 108 (for example, executing as a cloud server) may be in communication with one or more clients 112a, 112b, and/or 112c. The extraction service server 108 may also be referred to simply as the extraction service 108. The extraction service 108 and/or client(s) 112 may each embody or execute on a computing system or device, as described hereinafter in conjunction with FIGS. 10-13. Hereinafter, the extraction service 108 may be used to represent all of the types of cloud computing systems or applications that provide a service to assist in the determination of structure in a web document.

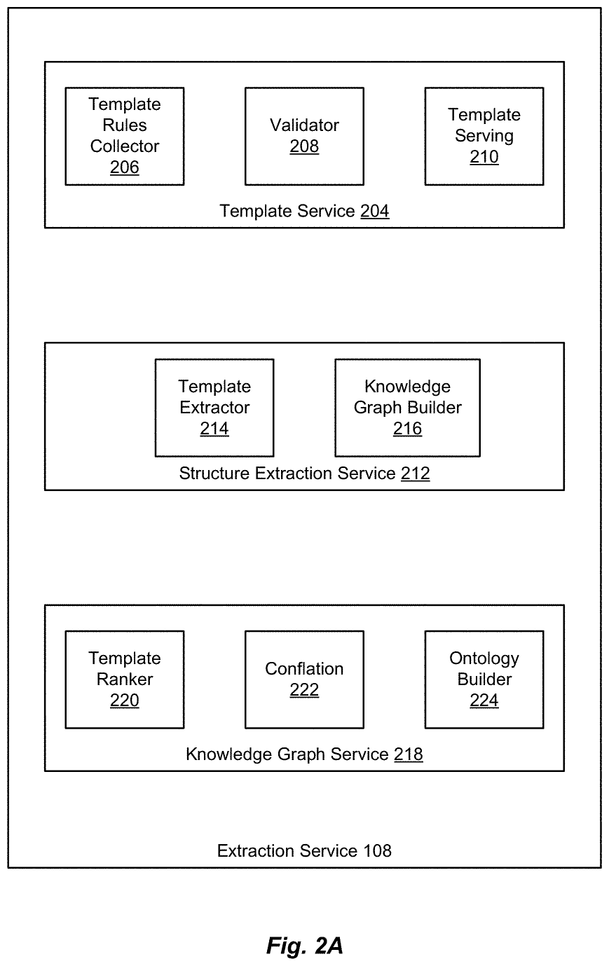

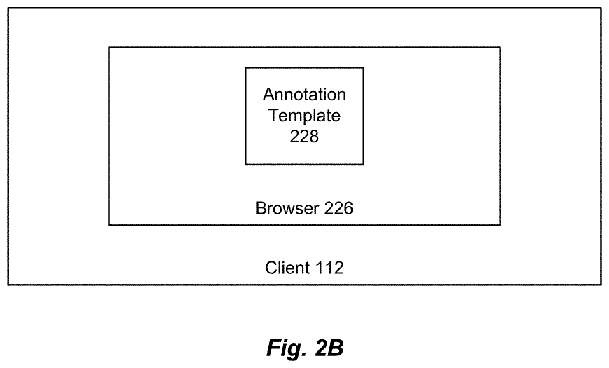

The extraction service 108 can include any hardware, software, or combination of hardware and software associated with a server, as described herein in conjunction with FIGS. 10-13. It should be noted that the extraction service 108 and the client 112 may execute portions of an application to evaluate web documents. An example of the extraction service 108 may be as described in conjunction with FIG. 2A.

The system 100 can also include one or more clients 112 that may be in communication with the extraction service 108 over the network 114. The client 112 can be any hardware, software, or combination of hardware and software associated with any computing device, mobile device, laptop, desktop computer, or other computing system, as described herein in conjunction with FIGS. 10-13. The client 112 can provide input, e.g., web document annotations, to the extraction service 108 or receive the output of the extraction service 108, e.g., the web document structure information and/or templates.

The extraction service 108 may communicate with the client 112 through a network 114 (also referred to as the “cloud”). The term “extraction service 108” can imply that at least some portion of the functionality of the extraction service 108 is in communication with the client 112. The network 114 can be any type of local area network (LAN), wide area network (WAN), wireless LAN (WLAN), the Internet, etc. Communications between the extraction service 108 and the client 112 can be conducted using any protocol or standard, for example, TCP/IP, JavaScript Object Notation (JSON), Hyper Text Transfer Protocol (HTTP), etc. Generally, commands or requests associated with analyzing a document are routed to the extraction service 108 for processing. The extraction service 108 may be in communication with, have access to, and/or include one or more databases or data stores, for example, the rules repository 116, content repository 120, the structure data repository 124, and/or knowledge graph repository 128.

The data stores 116-128 can be any data store, data repository, information database, memory, cache, etc., which can store web documents, content, templates, rules, knowledge information, and/or structures provided to or generated by the extraction service 108. The data stores 116-128 can store the information in any format, structure, etc. on a memory or data storage device, as described in conjunction with FIGS. 10-13.

The rules repository 116 can store the rules generated from the annotations provided by one or more clients 112. The rules include how to construct templates and structures as stored in the structure data repository 124. Rules can include algorithms to determine types of content within the web content, how to label such content, the location of the content within the web content page, etc. The rules form the initial development of template information used to extract structure from various web content and create knowledge for different domains.

The content repository 120 includes the content, metadata, and/or other information about the web document provided to the extraction service 108 and can include one or more of, but is not limited to, content within an electronic document (e.g., text, pictures, video, audio, etc.), metadata (e.g., type of document, subject, author, title, date of publication, source of publication, time when document was provided, locations of document (e.g., Uniform Resource Locator(s) (URLs), etc.), where the various documents are stored, etc.), and/or other information that may be specific to the web document(s) provided by or to the extraction service 108. It should be noted that web documents will be described herein, but the aspects herein may apply to other types of content or content structures.

The structure data repository 124 can include information or machine learned document structures, associated with web documents provided to the extraction service 108, which may be provided to the client 112 to allow the client 112 to understand a web document. For example, the structure library 124 can include one or more structures generated on similar web documents to that provided by the client 112. The provided structure from the structure library 124 can allow other applications to use the structure data for other purposes, for example, improved searching. Further, the structure library 124 may store metadata or other information about the structures. The metadata or other information can include one or more of, but is not limited to, the document associated with the structure, the configuration of the document, the author, the configuration of the application or software used to create the document, etc.

Knowledge graph repository 128 can store knowledge generated from one or more templates associated with the domain. The knowledge graphs build upon sets of templates to understand a complete domain's construction. The knowledge graph repository 128 stores the knowledge used to search or provide data to other applications or to use the templates and other rules constructed from annotated web content.

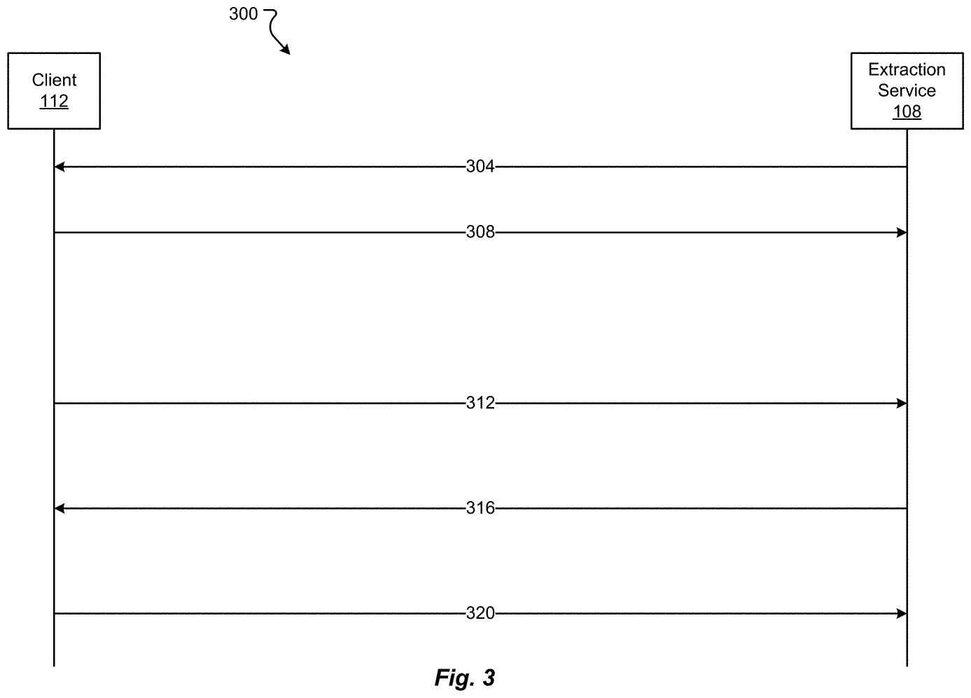

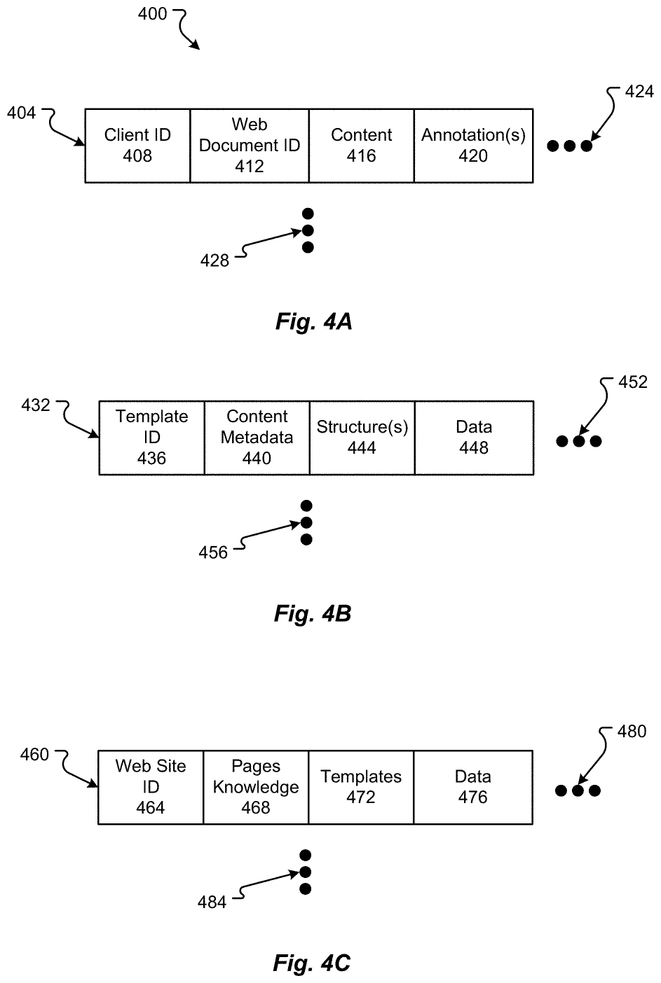

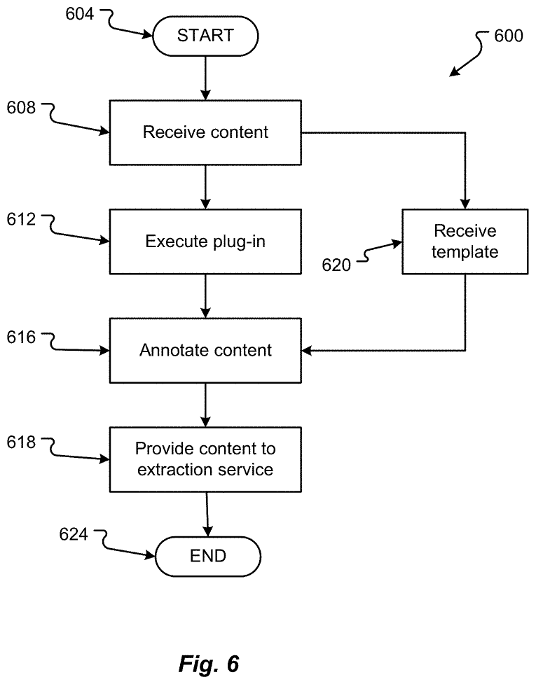

The client 112 can provide the annotated web document and/or receive the template structures from one or more of the data stores 116-128. Then, the client 112 can review the document, possibly using the template to improve the quality of the review of the document, on the user interface of the client device. The process(es) for determining a structure associated with a web document may be as described in conjunction with FIGS. 6-9. The data stored, retrieved, or exchanged between components 108 and/or 112 may be as described in conjunction with FIGS. 4A-4C. The exchange of signals may be as described in conjunction with FIG. 3.

An example configuration of an extraction service 108 may be as shown in FIG. 2A. The extraction service 108 may include one or more of, but is not limited to, a template service 204, structure extraction service 212, and knowledge graph service 218. Each of the components 204, 212, and 218 can be executed in one or more computer systems. Thus, one component may be executed in a first computer system and another component may be executed on another computer system. The various components 204, 212, and 218 can be machine learning (ML) models that determine a semantic structure from an annotated web document, generated templates that define the structure of the web document, and/or develop knowledge for a domain built from the templates or rules associated with the sematic structure. Each of the components 204 through 224 may be hardware, software, or hardware and/or software.

A template service 204 can train a machine learning (ML) model for a convolution neural network (CNN). The template service 204 may then apply the ML model to determine a structure of a web document. The template service 204 can receive, from the client 112, the document and/or metadata associated with the annotated web document(s). From the annotated document and metadata, the template service 204 can create at least one ML model associated with that type of document. The ML model may then be used to determine a web document structure for documents that may be delivered to the client 112 or used in another application. As such, the template service 204 can train models for various types of web documents, where those models are specific to the type of web document, the metadata, and/or the user needs. These generated models may be stored in the structure data repository 124.

A configuration of the template service 204 can include one or more of, but is not limited to, a template rules collector 206, a validator component 208, and/or a template serving component 210. The template rules collector 206 can create a set of rules associated with the annotated web document. As such, the template rules collector 206 can determine, from the annotated web content, the rules used to create a template or understand the content as annotated by the client 112. Template rules collector 206 then may be input into templates to determine structure in future web documents from the same domain or having similar content.

The validator component 208 can validate the rules produced by the template rules collector 206. The validator component 208 can resolve discrepancies or conflicts between two or more sets of the template rules generated from different annotated web content by the template rules collector 206. Thus, the validator component 208 can find similar limitations, elements, rules, etc. generated from different annotated web content and can indicate that the rule is validated. However, when there are conflicts between different rules generated by template rules collector 206 from different annotated web content, the validator component 208 can determine which of the rules is to be validated, stored, and/or used. For example, the validator component 208 can deploy a voting system among validator components, can analyze metadata to determine rule recency or frequency of use, or execute some other algorithm to indicate how to resolve conflicts between different conflicting rules. A validated rule may then be provided to the template serving component 210.

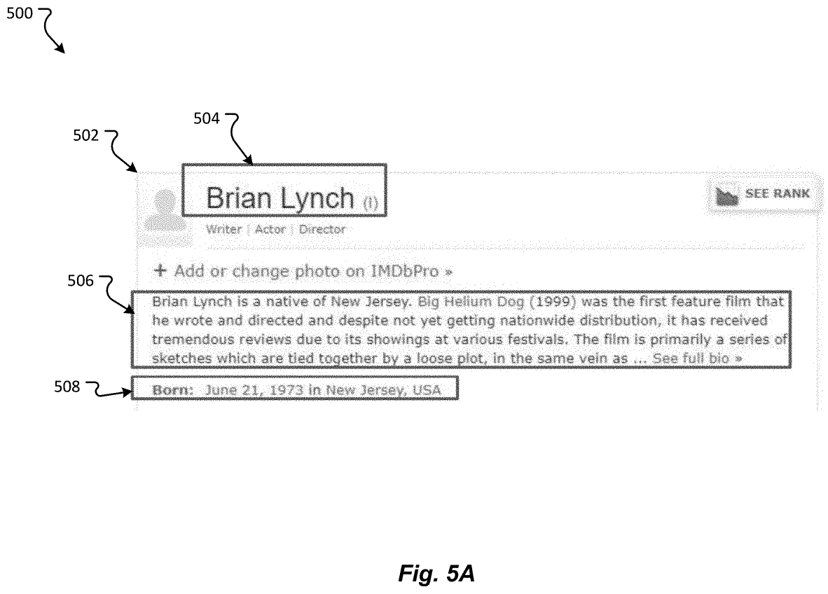

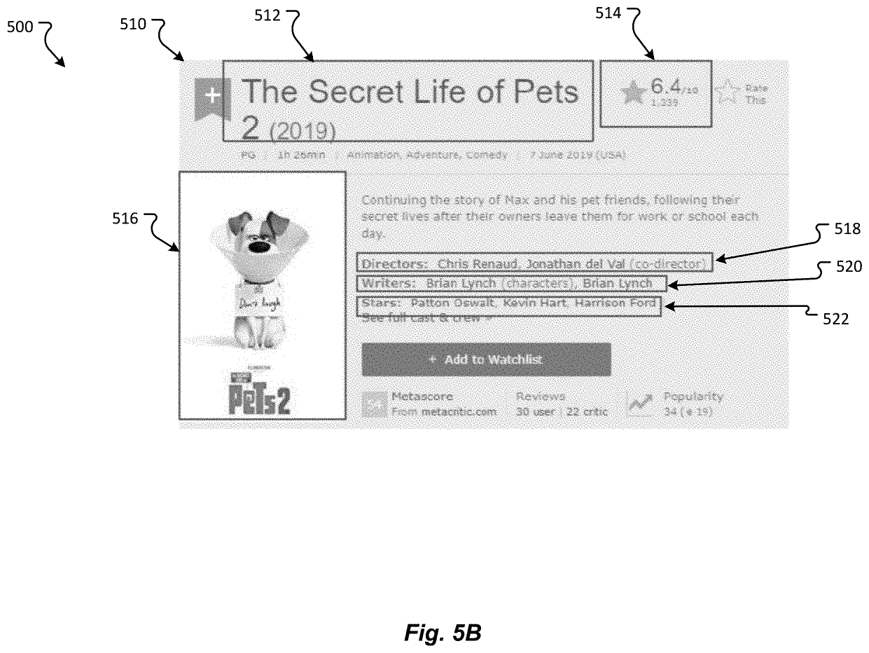

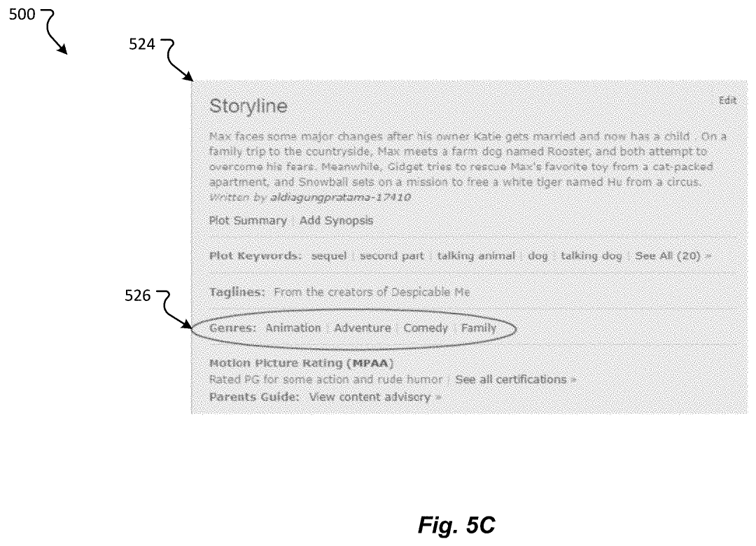

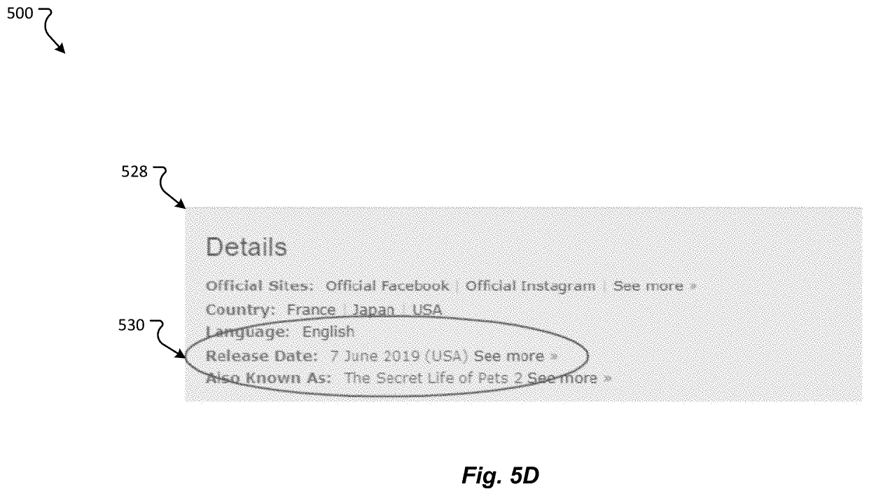

Template serving component 210 can construct templates for web content based on the validated rules from the validator component 208. Template serving component 210 may construct templates from the different template rules. Thus, for each item of web content in a domain, the template serving component 210 can construct a template that indicates the structure of that web content as described below in conjunction with FIGS. 5A through 5D.

A structure extraction service 212 may develop information from the results of the analysis of the template service 204. The structure extraction service 212 may also develop an ML model for a CNN to determine knowledge from the templates. Thus, the ML model of the structure extraction service 212 develops further information from the output of the template service 204. The structure extraction service 212 can include one or more of, but is not limited to, a template extractor 214 and/or a knowledge graph builder 216. A template extractor 214 can identify structure elements in the web document, from the templates provided by the template serving component 210, and can identify the structural elements in the templates. The template extractor 214 can analyze one or more templates to determine different structures within the same domain or web content that indicates the type of structure. The template extractor 214 can also label or identify the type of structure and provide this information to the knowledge graph builder 216.

The structure extraction service 212 can also include a knowledge graph builder 216 that can construct a knowledge graph of information including the different structures in web content associated with the domain. A knowledge graph indicates information about a domain and the webpages therein including what information may be provided from that domain, where that information may be stored, and how best to apply that information to other applications, for example, a search application. The knowledge graph information may be stored in the knowledge graph repository 128 by the knowledge graph builder 216.

The extraction service 108 can also include a knowledge graph service 218. The knowledge graph service 108 can construct knowledge graph information from the templates and interface with the knowledge graph builder 216 to generate the knowledge graphs. The knowledge graph service 218 can include one or more of, but is not limited to, a template ranker 220, a conflation component 222, and an ontology builder 224. The template ranker 220 can receive two more templates and rank those templates based on the template's likelihood to provide knowledge about the domain from which the template was created. The template ranker 220 can use various types of metadata or other information about the templates or domains, and/or the user that annotated the web content to generate a ranking. For example, if a user provides or has provided better annotations in the past, templates built from that user may then be ranked higher than some other user. Other such types of algorithms can be used to rank the templates and provide those rankings to the conflation component 222.

The conflation component 222 can combine the templates or reduce the templates into a single or into a smaller set of template information. Conflation can include determining what types of information may be within the templates, which templates provide the best information based on template raking or other information, or other types of analysis. The output of the conflation component 222 can be a single or a reduced set of information about a domain and the web content within that domain. The conflated information may be provided to the ontology builder 224. The ontology builder 224 can construct an ontology based on the conflated information from the conflation component 222.

The ontology builder 224 can then construct an ontology, for example, the representation and naming of the various properties, categories, and relationships between the data, the web content, domains, etc., based on the templates. The ontology may then be used by or for other applications to produce results that may encompass or include the web content made part of the ontology. Thus, the ontology builder 224 can store the information generated from the extraction service 108 that may be provided to other applications or users.

A configuration of the client 112 may be as shown in FIG. 2B. The client 112 can include a browser 226, for example a web browser, for viewing web content. The web browser 226 may include an additional annotation template application 228. The annotation template application 228 can be a browser plug-in, a mobile device application, a desktop application, etc., that may execute at the client-side device. The annotation template application 228 may, in some configurations execute in the browser 226 but the aspects are not limited to that configuration. The annotation template application 228 can allow the user to annotate web content when viewing web content in the browser 226. The annotations made by the client 112 may be as shown in FIGS. 5A through 5D. These annotations may then be sent, by the client 112, to the extraction service server 108 for use in building templates.

An embodiment of a signaling process 300 used in conjunction with the processes and methods described herein may be as shown in FIG. 3. The extraction service 108 can send the application code to the client 112, in signal 304. The application 228 may be installed and executed at the client 112, in the web browser 226, as described in conjunction FIG. 2B. Thereinafter, the client 112 can annotate web content using the application 228. The annotated content can be sent from the client 112 to the extraction service 108, as signal 308.

Sometime thereafter, the client 112 can send a search request, another request, or other interaction to the extraction service 108 or other service, in signal 312. As part of the interaction, the extraction service 108 can send a template associated with the requested web content, in signal 316. The template may be sent automatically in response to the search or other request and then allow the client 112 to update the template with new or additional annotations on the same or new, similar content. The client 112 may make further annotations into the web content based on the template received, in signal 316, and send the new annotations, in signal 320. These new annotations may then be used to update the template or other information associated with that web content.

Configurations of data and data structures 400 that can be stored, retrieved, managed, etc. by the system 100 may be as shown in FIGS. 4A-4C. The data structures 400 may be part of any type of data store, database, file system, memory, etc. including object-oriented databases, flat file databases, file systems, etc. The data structures 400 may also be part of some other memory configuration. The databases, signals, etc. described herein can include more of fewer data structures 400 than those shown in FIGS. 4A-4C.

The data structure 404, shown in FIG. 4A, can represent the annotated web content produced by the annotation template application 228 and sent from the client 112 to the extraction service 108, as signal 404. The data structure 404 can include one or more of, but is not limited to, a client identifier (ID) 408, a content ID 412, content 416, and/or annotations 420. There may be more or fewer data fields in data structure 404, as represented by ellipses 424. Each web document can include a data structure 404 in the data structures 400, and thus, there may be more data structures 404 in the system 100, as represented by ellipses 428.

The client ID 408 can include any type of information that can uniquely identify the client 112 from other clients 112 in communication with the extraction service 108. Thus, the client ID 408 can include an Internet Protocol (IP) address, another address or identifier of the client 112, a numeric ID, a uniform resource locator (URL), an alphanumeric ID, a globally unique ID (GUID), etc.

The web document ID 412 can include any type of information that can uniquely identify the web document reviewed and annotated by the client 112. Thus, the web document ID 412 can also include an Internet Protocol (IP) address, an address or identifier of the client 112, a numeric ID, a uniform resource locator (URL), an alphanumeric ID, a globally unique ID (GUID), a domain identifier, a document name or title, a combination of one or more of the previous items of information, etc.

The content 412 can comprise the contents of the web document. For example, the content 412 can include one or more of, but is not limited to, text, pictures, embedded objects, video, audio, graphs, lists, paragraphs, tables, presentation slides, other multimedia, etc. The content 412 may not include structure information that describes the format of the web document.

The annotations 420 can include one or more markings or other indicators, generated by the client 112, which indicates a type of content within a portion of the web document. The annotation 420 can include location information, data about a visual indicator that marks the annotation, information supplied by the client 112 with the annotation (e.g., what the content is describing), etc. Examples of annotations may be as described in conjunction with FIGS. 5A-5D.

A configuration of a data structure 432, which may represent a template, may be as shown in FIG. 4B. The data structure 432 represents a template output from the system 100. The data structure 432 can include one or more of, but is not limited to, a template ID 436, content metadata 440, structures 444, data 448, etc. There may be more or fewer fields in data structure 432, as represented by ellipses 452. There may also be one or more templates within data structure 400, as represented by ellipses 456.

The template ID 436 can include any type of information that can uniquely identify the template associated or generated from the web document reviewed and annotated by the client 112. Thus, the template ID 436 can also include an a numeric ID, a uniform resource locator (URL), an alphanumeric ID, a globally unique ID (GUID), a domain identifier, a document name or title, a combination of the previous items, etc.

The content metadata 440 can include any metadata about the content of the web document as annotated by the client 112. The metadata 440 can include information that may be used by the knowledge graph builder 216, with the knowledge graph service 218, to construct knowledge or information from the templates identified in data structure 432. The metadata 440 can include one or more of, but is not limited to, the web document ID 412, the domain of the web document, the author of the web document, the date publishing of the web document, sentiment within the web document, a number of words within the web document, the time of publishing of the document, etc.

The structures 444 can include information about the different elements within the web document and provided in the template. Structures 444 can include one or more of, but is not limited to, paragraphs, pictures, video, audio, other multimedia, sentences, captions, frames, embedded frames, or other structures or elements within the web document. The structures 444 can be used to identify content or other structures within other web documents similar to the one having been annotated and provided by the client 112. Thus, the template 432 can provide ML model information for identifying content in other web documents without having those web documents annotated.

Data 448 can include any information or data about the web document or the structures 444. The data 448 can include the data within the structures, for example, the content. Data 448 can also include the information about what the structure represents or what data the structure may contain. For example, the data 448 can include the type of structure identified, the type of content found in the structure of 444, or other information that delineates what information is within the web document.

Alternatively or additionally, the data 448 can include information about the template. For example, data 448 can include what web document was used to create the template, when the template was created, the number of structures 444 in the template, the domain to which the template is associated, or other information. Thus, data 448 can be used by the knowledge graph builder 216 and the knowledge graph service 218 to construct the knowledge graph about the domain with the template(s).

A configuration of another data structure 460, which may represent information in the knowledge graph, may be as shown in FIG. 4C. The data structure 460 represents the knowledge built from the templates by the system 100. The data structure 460 can include one or more of, but is not limited to, a web site ID 464, page knowledge 468, templates 472, data 476, etc. There may be more or fewer fields in data structure 460, as represented by ellipses 480. There may also be more knowledge graphs within data structures 400, as represented by ellipses 484.

The web site ID 464 can include any type of information that can uniquely identify the domain or web site associated with the portion of the knowledge graph. Thus, the web site ID 464 can include a web site address or name, a uniform resource locator (URL), an alphanumeric ID, a globally unique ID (GUID), another domain identifier, etc.

The pages knowledge 468 can include any data or metadata about the content of the web site. The pages knowledge 468 can include information that may be generated by the knowledge graph builder 216 or the knowledge graph service 218 when constructing the knowledge or information from the templates identified in data structure 432. The pages knowledge 468 can include one or more of, but is not limited to, the number of pages in the domain, a tree diagram of the pages, the web document IDs 412 for the pages, the frequency of visits to the pages, the author of the domain and/or pages, sentiment within the web documents, a number of words in the domain, the type of content in the domain and/or pages, the date or time of publishing of the documents and/or pages, etc.

The templates 472 can include the listing of the one or more templates associated with the one or more pages of the domain or website. For example, templates 472 can include the template ID 436 of the templates associated with the website. Further, the template 472 can also include a pointer, indicator, or other item of information that identifies the page within the domain that is associated with the template or the location of the template itself. Templates 472 can also include a tree diagram or other type of relationship diagram of the various templates.

Data 476 can include any information or data about the web site. The data 476 can include domain information, for example, the identifier for the template collection. Data 476 can also include the information about what the domain is for, what the domain may contain, or other information. For example, the data 476 can include what type of content is provided by the domain, what content will be or can be found with the templates, or other information that delineates what information is within the web site.

Alternatively or additionally, the data 476 can include information about the templates in the domain. For example, data 476 can include what web document is related to each template, when the templates were created, the number of templates, or other information. Thus, data 476 can be used by other applications to find information in the domain with the templates.

User interfaces that show annotations, by clients 112 and as received by the extraction service 108, may be as shown in FIGS. 5A-5D. The several user interfaces in FIGS. 5A through 5D represent visually how a client 112 can supply annotations that indicate a structure of a web document. These annotations can be analyzed to generate templates and, from the templates, a knowledge graph of the domain.

An example of an annotated web document 500 may be as shown in FIG. 5A. In this example, the web document 500 may be information about an actor in a movie. The annotations may be as shown by boxes 504, 506, and/or 508. In the example in FIG. 5A, the annotations are provided visually by the boxes 504-508. However, annotations may be given in different forms using different visual indicators, visual indicia, or by use of other input types that are not visual.

A first box 504 can indicate the name of the actor in the movies. The box 504 may provide a location (by the placement of the box 504) for where the name of the actor may be found within the web document 502. Thus, the visual indicator 504 can provide information, such as location, that can be used to generate the templates. The client 112 may also indicate information about the box, for example, that the box 504 is location of the name of the actor within the web document 502.

Likewise, box 506 can indicate the location of the biographical information about the actor within the web document 502. Box 508 can indicate the birth date and birthplace of the actor. In a similar manner, box 508 can indicate a location of the birth information within the web document 502. Other information may also be gleaned from the annotations 504 through 508 within the web document 502. For example, there may be a relationship generated between the boxes 504-3508 and/or a relative location for each box 504-3508 may be determined or based on the location of one or more the other boxes.

Some of this information may be generated automatically. In some instances, the annotations may be a selection of frames, sub frames, embedded frames, or other website elements within the web document 502. When one of those web document elements are selected, metadata about those elements may be extracted from Hypertext Markup Language (HTML), Extensible Markup Language (XML), or other code associated with the web document. For example, when selecting the element that has the actor's name in box 504, the annotation template application 228 can extract the metadata about the element 504 from the underlying HTML code.

Another example of an annotated web document 510, which may be included in the various annotated documents 500, may be as shown in FIG. 5B. In this example, a web document 510 may be information about a movie rather than an actor. Similar annotations may be made, but those annotations may include different elements within the web document and/or different web pages. For example, visual indicia 512 can indicate the title of the movie and may include the metadata or other information about that element within the web document 510. Visual indicia 514 can indicate an annotation for the location of the rating of the movie and can include various other information about that rating.

The annotations can also include indicators for items other than text, for example, annotation 516 identifies a movie poster or other picture or visual media associated with the movie. Thus, the annotations can be more than just textual information. In another example, an annotation can indicate a movie trailer that may be played in a player in the web document.

Boxes 518, 520, and/or 522 indicate other information about the movie. For example, box 518 indicates the directors, box 520 indicates the writers of the movie, and box 522 indicates the stars or actors involved with the movie. As should be noted, the boxes 518-522 annotate locations of links to other web materials or other web documents. The links or other associations may be included in the metadata of the annotations. Such links or other URL information can be used in the templates and later in the knowledge graph to build relationships between templates.

Another web document 524, which may be a web document from a same set of web documents 500, may also be annotated as shown in FIG. 5C. In this example, a different type of annotation is made, namely, an ellipse 526 is placed over a portion of the web document 524. In some configurations, different types of visual indicia, for example, the box or the ellipse, can indicate different types of information or convey different information to the template service 204. For example, the ellipse 526, in the web document 524, can indicate a broader category of information about the web document. In this instance, the ellipses 526 can indicate the genre of the movie. This more general information can be used for organizing the domain, by the knowledge graph service 218 or knowledge graph builder 216.

Another web document 528, which may be included in the set of web documents 520 in a same domain, may be as annotated in FIG. 5D. Again, an ellipse visual indicator 530 is used to mark information within the web document 528. In the example shown in FIG. 5D, visual indicator 530 can indicate the release date of the movie. The annotation 530 can also indicate a link to more information that is provided by the “See more” link within the web document 528. Thus, the visual indicator 530 can indicate a link to more information within the web document 528.

Thus, as explained above, the annotations can provide various information either provided by the client 112, through text or other types of inputs. Additionally or alternatively, the use of various different types of visual indicia, by the placement or selection of elements within the web documents, etc. can also provide different types of information. Further, the annotations may also provide information automatically by the extraction of information about the web document from HTML or other sources. In this way, the annotations are rich with information that may be used to generate the templates.

A method 600, as conducted by the client 112, for annotating a web document may be as shown in FIG. 6. A general order for the steps of the method 600 is shown in FIG. 6. Generally, the method 600 starts with a start operation 604 and ends with an end operation 624. The method 600 can include more or fewer steps or can arrange the order of the steps differently than those shown in FIG. 6. The method 600 can be executed as a set of computer-executable instructions executed by a computer system and encoded or stored on a computer readable medium. Further, the method 600 can be performed by gates or circuits associated with a processor, an application specific integrated circuit (ASIC), a field programmable gate array (FPGA), a system-on-chip (SOC), or other hardware device. Hereinafter, the method 600 shall be explained with reference to the systems, components, devices, modules, software, signals, data structures, interfaces, methods, etc. described in conjunction with FIGS. 1-5 and 7-13.

The browser 226 of the client 112 can receive content, in step 608. The content can include one or more web documents from a domain that may be viewed on a user interface of the client 112. The content can have one or more elements that may be annotated by the client 112.

Client 112 can receive an annotation template application 228 in signal 304. The client 112 can install the annotation template application 228, which may execute through a browser, in step 612. With the annotation template application 228, the client can annotate the content received in step 608.

The client 112 may then annotate the content within the web document using the template application 228, in step 616. As explained in conjunction with FIGS. 5a through 5D, the client 112 may provide visual indicia within the web document, for example, boxes 504-508 as shown in web document 502 of FIG. 5A. Along with or instead of providing visual indicia, the client 112, with the annotation template application 228, can provide textual or other types of input about one or more elements within the web document 502. The textual or other info puts may also be part or associated with the visual indicia (possibly as metadata). In some configurations, annotation template application 228 can also extract automatically information about the elements 504-508 based on HTML code or other sources of information.

These annotations may be bundled into an annotated web document and then provided to the extraction service 108, as signal 308, in step 618. Thus, some or all information provided or generated by the annotation template application 228 may be provided as a single document, similar to that provided as data structure 404, in FIG. 4A. The client 112 may be identified with client ID 408 (to allow for template ranking) and the annotations 420 may be placed in the data structure 404 that is sent in signal 308.

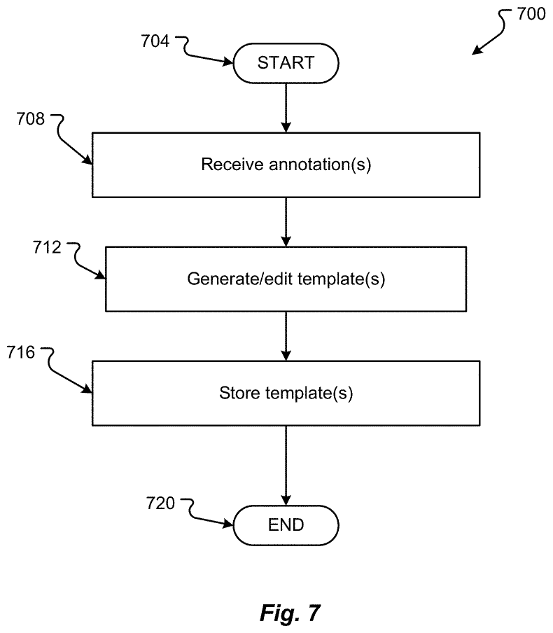

A method 700, as conducted by the extraction service 108, for generating templates from annotated web documents may be as shown in FIG. 7. A general order for the steps of the method 700 is shown in FIG. 7. Generally, the method 700 starts with a start operation 704 and ends with an end operation 720. The method 700 can include more or fewer steps or can arrange the order of the steps differently than those shown in FIG. 7. The method 700 can be executed as a set of computer-executable instructions executed by a computer system and encoded or stored on a computer readable medium. Further, the method 700 can be performed by gates or circuits associated with a processor, an ASIC, a FPGA, a SOC, or other hardware device. Hereinafter, the method 700 shall be explained with reference to the systems, components, devices, modules, software, signals, data structures, interfaces, methods, etc. described in conjunction with FIGS. 1-6 and 8-13.

The extraction service 108 may receive the annotations in signal 308, in step 708. The annotations and the associated content may be provided in data structure 404, which may be received by the template service 204, and stored in content repository 120 for further processing. The template service 204 may then read the annotations, for example, annotations 504-508 from the annotated web document 502. The information read from the annotated content may be provided to the template rules collector 206.

The template service 204 may then generate one or more templates from the annotated web content, in step 712. In this example, the template rules collector 206 can extract or generate rules based on the annotations provided in data structure 432. The rules can include information or indications about locations of content within the web document 502, the type of content contained within elements within the web document, relationships between various elements within the web document, or other information to build a template that can be used to identify similar content or information from other similarly formatted or structured web documents in the same domain or similar domains. The rules generated by the rules component 206 may be stored in rules repository 116. In some configurations, the rules may require validation, and, as such, more than one set of rules may be based off of the same web content and then validated and/or conflated. These various rules may be stored in rules repository 116 before being provided to a validator 208.

The rules may then be provided to the validator 208 which can validate the effectiveness or efficacy of the rules based on whether those rules may be applied to other web content. Validation can also ensure the rules created are legitimate and not part of a phishing or other attack or other nefarious activity. Validated rules may then be provided to the template serving component 210. The template serving component 210 can then construct the template with the various structures 444 in the indicated location and with the content types.

The generated templates may be stored as data structure 432, in step 716. Thus, the template serving component 210 can construct the data structures 432 and store those data structures in structure data repository 124. The one or more templates can then be provided to a knowledge graph builder 216 and/or knowledge graph service 218 for building knowledge about the domain based off of the one or more templates associated with the domain.

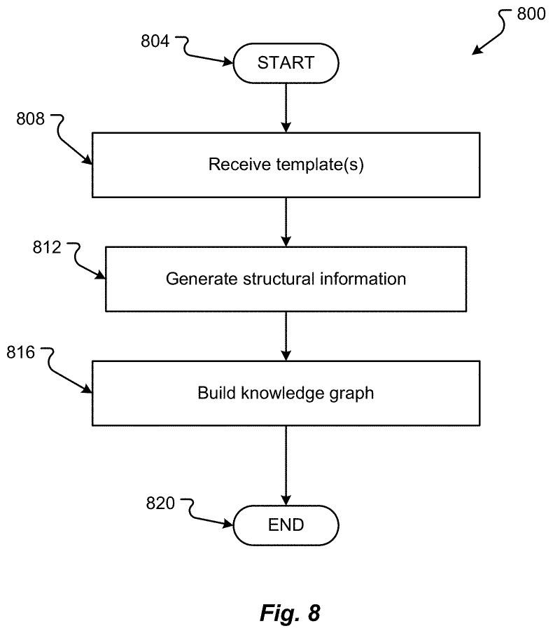

A method 800, as conducted by the extraction service 108, for building a knowledge graph from the generated templates may be as shown in FIG. 8. A general order for the steps of the method 800 is shown in FIG. 8. Generally, the method 800 starts with a start operation 804 and ends with an end operation 820. The method 800 can include more or fewer steps or can arrange the order of the steps differently than those shown in FIG. 8. The method 800 can be executed as a set of computer-executable instructions executed by a computer system and encoded or stored on a computer readable medium. Further, the method 800 can be performed by gates or circuits associated with a processor, an ASIC, a FPGA, a SOC, or other hardware device. Hereinafter, the method 800 shall be explained with reference to the systems, components, devices, modules, software, signals, data structures, interfaces, methods, etc. described in conjunction with FIGS. 1-7 and 9-13.

The structure extraction service 212 can receive one or more templates from the template service 204, in step 808. The templates may be provided as data structures 432 retrieved by the structure extraction service 212 from the structure data repository 124. The received templates 432 may then be provided to the template extractor 214.

The template extractor 214 can generate structural information from the one or more templates, in step 812. The template extractor 214 can review the structural elements provided in the template, as stored in field 444 of data structure 432. The structures 444 may are as provided in one or more templates that are validated and understood to be good structural information. The information about these structures may then be stored by the structure extraction service 212. Further, this structure information may be provided as information page knowledge 468 or templates information 472 in data structure 460.

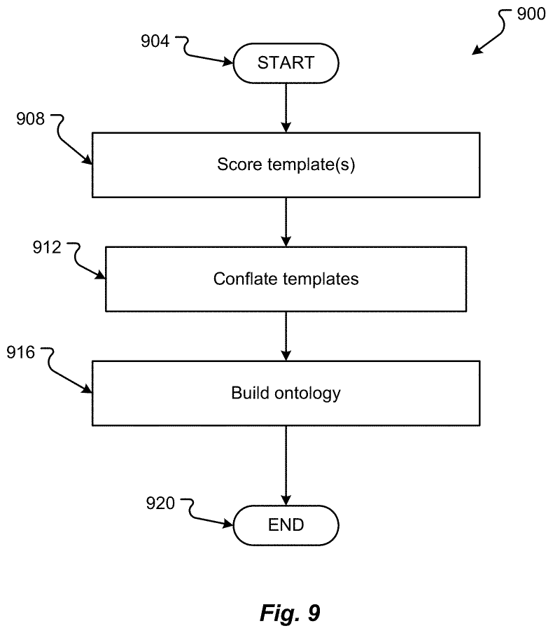

A knowledge graph builder 216 may then build the knowledge graph associated with the domain containing the one or more templates, in step 816. In an example, the knowledge graph builder 216 can employ the services of the knowledge graph service 218 to build information from the templates. The information, such as the ontology and other information provided by the knowledge graph service 218, can be stored in data structure 460. For example, the knowledge generated from the templates may be stored as page knowledge 468, templates information 472, and/or data 476 may be stored in data structure 460, by the knowledge graph builder 216, for provision to other applications or other clients 112. An example of the processes performed by the knowledge graph service 218 may be as described in conjunction with FIG. 9.

A method 900, as conducted by the extraction service 108, for building knowledge about domains may be as shown in FIG. 9. A general order for the steps of the method 900 is shown in FIG. 9. Generally, the method 900 starts with a start operation 904 and ends with an end operation 920. The method 900 can include more or fewer steps or can arrange the order of the steps differently than those shown in FIG. 9. The method 900 can be executed as a set of computer-executable instructions executed by a computer system and encoded or stored on a computer readable medium. Further, the method 900 can be performed by gates or circuits associated with a processor, an ASIC, a FPGA, a SOC, or other hardware device. Hereinafter, the method 900 shall be explained with reference to the systems, components, devices, modules, software, signals, data structures, interfaces, methods, etc. described in conjunction with FIGS. 1-8 and 10-13.

A template ranker 220, of the knowledge graph service 218, may receive one or more templates. The template ranker 220 may then score the templates, in step 908. To score the templates, the template ranker 220 may review or analyze content metadata 440 and/or data 448, of the template data structure 432. Based on information within data structure 432, the template ranker 220 can score or indicate which of the various templates, which may be associated with the same or similar web content, can provide the best information about the structure of the web pages. This ranking information may then be passed to the conflation component 222.

The conflation component 222 may then conflate the templates, in step 912. Conflating the templates may include building structural information about or from the templates based on the score provided by the template ranker 220 or other information in data structures 404 and 432. The conflation component 222 can reduce the data size of the various templates into a single or smaller working set of rules or structures based on the templates. The smaller structure of information may then be provided to the ontology builder 224.

The ontology builder 224 can build an ontology, in step 916. In an example, from the conflated template information, the ontology builder 224 can generate information or data about the elements, structures, and other various information about the web pages or web content within the domain. This domain information describing elements, templates, content hierarchy, relationships, and other structures, both within the web pages and between web pages within a domain, may be stored in data structure 460 as pages knowledge 468, data 476, or templates 472. The ontology provides overall structural information or data for other applications to use.

Thus, the extraction service 108 can use the annotated web documents as source information to build a knowledge graph ontology for a domain. In this way, the extraction service 108 has advantages over other systems that have to use a ML model training set, marked up by the employees or other people, rather than be provided with the assistance of clients and/or end users who may be more familiar with the web content there annotating and also may be able to provide a larger more robust set of web annotations. Thus, the starting set of information to build the ontology, by the extraction service 108, is more detailed, larger, more effective, more efficient, and higher-quality. Because of these advantages, the extraction service 108 can build a better knowledge graph than other types of systems.

FIG. 10 is a block diagram illustrating physical components (e.g., hardware) of a computing device 1000 with which aspects of the disclosure may be practiced. The computing device components described below may be suitable for the computing devices described above. In a basic configuration, the computing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combination of such memories. The system memory 1004 may include an operating system 1005 and one or more program modules 1006 suitable for performing the various aspects disclosed herein. The operating system 1005, for example, may be suitable for controlling the operation of the computing device 1000. Furthermore, aspects of the disclosure may be practiced in conjunction with a graphics library, other operating systems, or any other application program and is not limited to any particular application or system. This basic configuration is illustrated in FIG. 10 by those components within a dashed line 1008. The computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, a number of program modules and data files may be stored in the system memory 1004. While executing on the processing unit 1002, the program modules 1006 (e.g., application 1020) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1000 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 1000 may also have one or more input device(s) 1012 such as a keyboard, a mouse, a pen, a sound or voice input device, a touch or swipe input device, etc. The output device(s) 1014 such as a display, speakers, a printer, etc. may also be included. The aforementioned devices are examples and others may be used. The computing device 1000 may include one or more communication connections 1016 allowing communications with other computing devices 1080. Examples of suitable communication connections 1016 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

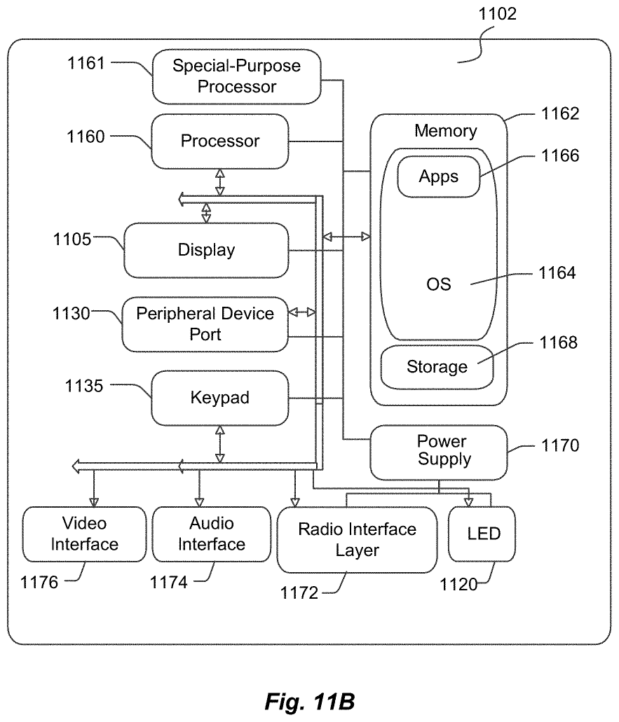

FIGS. 11A and 11B illustrate a computing device or mobile computing device 1100, for example, a mobile telephone, a smart phone, wearable computer (such as a smart watch), a tablet computer, a laptop computer, and the like, with which aspects of the disclosure may be practiced. In some aspects, the client (e.g., computing system 108, 112) may be a mobile computing device. With reference to FIG. 11A, one aspect of a mobile computing device 1100 for implementing the aspects is illustrated. In a basic configuration, the mobile computing device 1100 is a handheld computer having both input elements and output elements. The mobile computing device 1100 typically includes a display 1105 and one or more input buttons 1110 that allow the client to enter information into the mobile computing device 1100. The display 1105 of the mobile computing device 1100 may also function as an input device (e.g., a touch screen display). If included, an optional side input element 1115 allows further client input. The side input element 1115 may be a rotary switch, a button, or any other type of manual input element. In alternative aspects, mobile computing device 1100 may incorporate more or less input elements. For example, the display 1105 may not be a touch screen in some aspects. In yet another alternative aspect, the mobile computing device 1100 is a portable phone system, such as a cellular phone. The mobile computing device 1100 may also include an optional keypad 1145. Optional keypad 1145 may be a physical keypad or a “soft” keypad generated on the touch screen display. In various aspects, the output elements include the display 1105 for showing a graphical client interface (GUI), a visual indicator 1120 (e.g., a light emitting diode), and/or an audio transducer 1125 (e.g., a speaker). In some aspects, the mobile computing device 1100 incorporates a vibration transducer for providing the client with tactile feedback. In yet another aspect, the mobile computing device 1100 incorporates input and/or output ports, such as an audio input (e.g., a microphone jack), an audio output (e.g., a headphone jack), and a video output (e.g., a HDMI port) for sending signals to or receiving signals from an external device.

FIG. 11B is a block diagram illustrating the architecture of one aspect of computing device, a server (e.g., server 108), or a mobile computing device. That is, the computing device 1100 can incorporate a system (e.g., an architecture) 1102 to implement some aspects. The system 1102 can implemented as a “smart phone” capable of running one or more applications (e.g., browser, e-mail, calendaring, contact managers, messaging clients, games, and media clients/players). In some aspects, the system 1102 is integrated as a computing device, such as document structure service server, client, and wireless phone.

One or more application programs 1166 may be loaded into the memory 1162 and run on or in association with the operating system 1164. Examples of the application programs include phone dialer programs, e-mail programs, personal information management (PIM) programs, word processing programs, spreadsheet programs, Internet browser programs, messaging programs, and so forth. The system 1102 also includes a non-volatile storage area 1168 within the memory 1162. The non-volatile storage area 1168 may be used to store persistent information that should not be lost if the system 1102 is powered down. The application programs 1166 may use and store information in the non-volatile storage area 1168, such as e-mail or other messages used by an e-mail application, and the like. A synchronization application (not shown) also resides on the system 1102 and is programmed to interact with a corresponding synchronization application resident on a host computer to keep the information stored in the non-volatile storage area 1168 synchronized with corresponding information stored at the host computer. As should be appreciated, other applications may be loaded into the memory 1162 and run on the mobile computing device 1100 described herein (e.g., search engine, extractor module, relevancy ranking module, answer scoring module, etc.).

The system 1102 has a power supply 1170, which may be implemented as one or more batteries. The power supply 1170 might further include an external power source, such as an alternating current (AC) adapter or a powered docking cradle that supplements or recharges the batteries.

The system 1102 may also include a radio interface layer 1172 that performs the function of transmitting and receiving radio frequency communications. The radio interface layer 1172 facilitates wireless connectivity between the system 1102 and the “outside world,” via a communications carrier or service provider. Transmissions to and from the radio interface layer 1172 are conducted under control of the operating system 1164. In other words, communications received by the radio interface layer 1172 may be disseminated to the application programs 1166 via the operating system 1164, and vice versa.

The visual indicator 1120 may be used to provide visual notifications, and/or an audio interface 1174 may be used for producing audible notifications via the audio transducer 1125. In the illustrated configuration, the visual indicator 1120 is a light emitting diode (LED) and the audio transducer 1125 is a speaker. These devices may be directly coupled to the power supply 1170 so that when activated, they remain on for a duration dictated by the notification mechanism even though the processor 1160 and other components might shut down for conserving battery power. The LED may be programmed to remain on indefinitely until the client takes action to indicate the powered-on status of the device. The audio interface 1174 is used to provide audible signals to and receive audible signals from the client. For example, in addition to being coupled to the audio transducer 1125, the audio interface 1174 may also be coupled to a microphone to receive audible input, such as to facilitate a telephone conversation. In accordance with aspects of the present disclosure, the microphone may also serve as an audio sensor to facilitate control of notifications, as will be described below. The system 1102 may further include a video interface 1176 that enables an operation of an on-board camera 1140 to record still images, video stream, and the like.

A mobile computing device 1100 implementing the system 1102 may have additional features or functionality. For example, the mobile computing device 1100 may also include additional data storage devices (removable and/or non-removable) such as, magnetic disks, optical disks, or tape. Such additional storage is illustrated in FIG. 11B by the non-volatile storage area 1168.

Data/information generated or captured by the mobile computing device 1100 and stored via the system 1102 may be stored locally on the mobile computing device 1100, as described above, or the data may be stored on any number of storage media that may be accessed by the device via the radio interface layer 1172 or via a wired connection between the mobile computing device 1100 and a separate computing device associated with the mobile computing device 1100, for example, a server computer in a distributed computing network, such as the Internet. As should be appreciated such data/information may be accessed via the mobile computing device 1100 via the radio interface layer 1172 or via a distributed computing network. Similarly, such data/information may be readily transferred between computing devices for storage and use according to well-known data/information transfer and storage means, including electronic mail and collaborative data/information sharing systems.

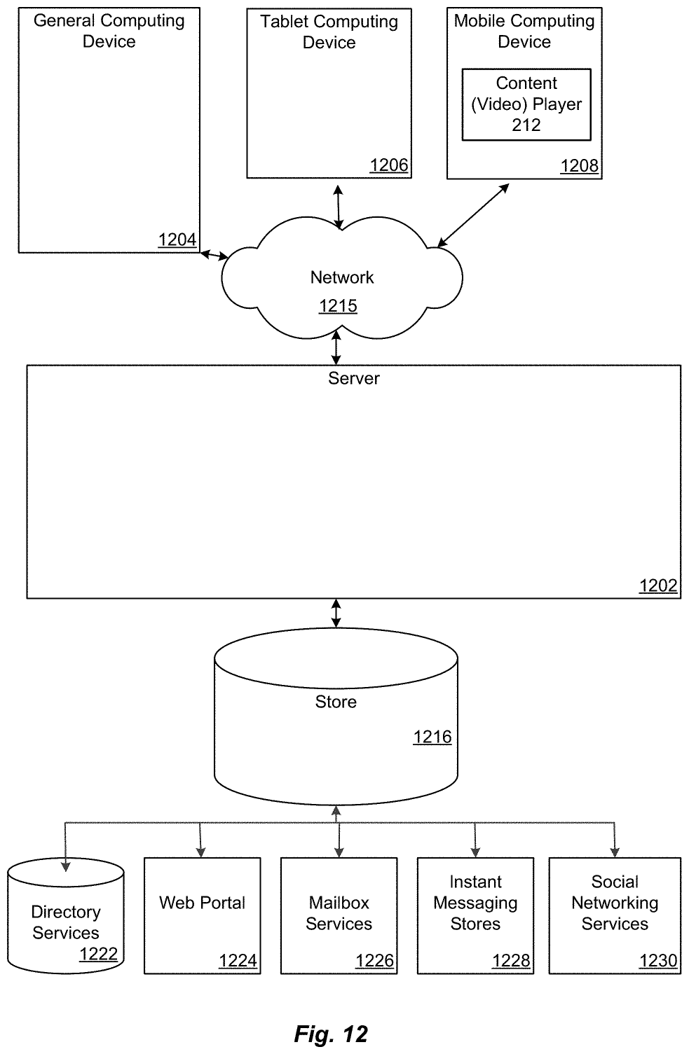

FIG. 12 illustrates one aspect of the architecture of a system for processing data received at a computing system from a remote source, such as a personal computer 1204, tablet computing device 1206, or mobile computing device 1208, as described above. Document displayed at server device 1202 may be stored in different communication channels or other storage types. For example, various documents may be stored using a directory service 1222, a web portal 1224, a mailbox service 1226, an instant messaging store 1228, or a social networking site 1240. Unified profile application programming interface (API) 1221 may be employed by a client that communicates with server device 1202, and/or attribute inference processor 1220 may be employed by server device 1202. The server device 1202 may provide data to and from a client computing device such as a personal computer 1204, a tablet computing device 1206 and/or a mobile computing device 1208 (e.g., a smart phone) through a network 1215. By way of example, the computer system described above may be embodied in a personal computer 1204, a tablet computing device 1206 and/or a mobile computing device 1208 (e.g., a smart phone). Any of these configurations of the computing devices may obtain document from the store 1216, in addition to receiving graphical data useable to be either pre-processed at a graphic-originating system, or post-processed at a receiving computing system.

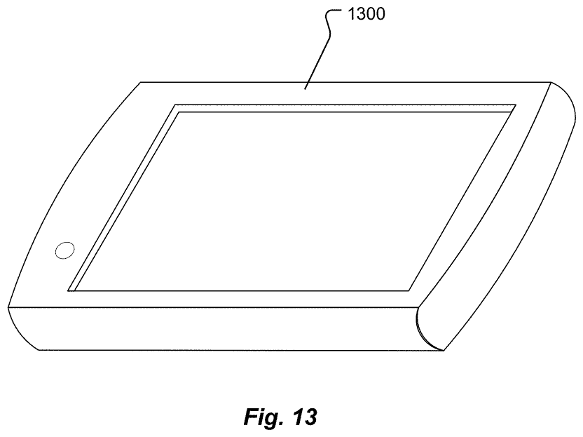

FIG. 13 illustrates an exemplary tablet computing device 1300 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

A number of variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an configuration with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Aspects of the present disclosure include a method comprising: receiving, at a template service, a first annotated web document from a first client associated with a web document; receiving, at the template service, a second annotated web document from a second client also associated with the web document, wherein the first annotated web document and the second annotated web document are associated with similar content from a same domain; based on the first annotated web document and the second annotated web document, generating a template indicating a structure of the web document; and storing the template in a template data store.

Any of the one or more above aspects, wherein the first annotated web document annotates a structure for a web document.

Any of the one or more above aspects, wherein the similar content is a first type of web document associated with the same domain.

Any of the one or more above aspects, further comprising, based on the template, generate structural information for a first type of web content.

Any of the one or more above aspects, further comprising build a knowledge graph from the structural information for the same domain.

Any of the one or more above aspects, wherein the knowledge graph comprises an ontology associated with the same domain.

Any of the one or more above aspects, wherein generating the template comprises generating a first template from the first annotated web document and a second template from the second annotated web document.

Any of the one or more above aspects, wherein generating the template further comprises ranking the first template over the second template.

Any of the one or more above aspects, wherein generating the template further comprises conflating the first template with the second template into a conflated template.

Any of the one or more above aspects, wherein the ontology is built from the conflated template.

Aspects of the present disclosure include a computer storage media having stored thereon computer-executable instructions that when executed by a processor causes the processor to perform a method, the method comprising: executing an annotation template application for a web browser; receiving a web document; annotating an element in the web document with the annotation template application to create an annotated web document; sending the annotated web document to an extraction service.

Any of the one or more above aspects, further comprising receiving the annotation template application from the extraction service.

Any of the one or more above aspects, wherein the annotation of the element is a visual indicia placed in the web document.

Any of the one or more above aspects, wherein the annotation of the element indicates a location of the element within the web document.

Any of the one or more above aspects, wherein the annotation of the element indicates a type of content associated with the element within the web document.

Aspects of the present disclosure include an extraction service server comprising: a memory having stored thereon computer-executable instructions; and a processor, in communication the memory, to execute the computer-executable instructions to perform a method comprising: receiving, at a template service executed with the processor, a first annotated web document from a first client; receiving, at the template service, a second annotated web document from a second client, wherein the first annotated web document and the second annotated web document are associated with similar content from a same domain; based on the first annotated web document and the second annotated web document, generating a template indicating a structure of the annotated web document; storing the template in a structural data repository; based on the template, generate structural information for the similar content; and build a knowledge graph from the structural information for the same domain.

Any of the one or more above aspects, wherein the first annotated web document annotates a structure for a web document.

Any of the one or more above aspects, wherein the knowledge graph comprises an ontology associated with the same domain.

Any of the one or more above aspects, wherein generating the template comprises generating a first template from the first annotated web document and a second template from the second annotated web document.

Any of the one or more above aspects, wherein generating the template further comprises: ranking the first template over the second template; and conflating the first template with the second template.

Any one or more of the aspects as substantially disclosed herein.

Any one or more of the aspects in combination with any one or more other aspects as substantially disclosed herein.

One or means adapted to perform any one or more of the above aspects as substantially disclosed herein.

1. A method comprising:
receiving, at a template service, a first annotated web document from a first client associated with a web document;
receiving, at the template service, a second annotated web document from a second client also associated with the web document, wherein the first annotated web document and the second annotated web document are associated with similar content from a same domain;
based on the first annotated web document and the second annotated web document, generating a template indicating a structure of the web document; and
storing the template in a template data store.

2. The method of claim 1, wherein the first annotated web document annotates a structure for a web document.

3. The method of claim 2, wherein the similar content is a first type of web document associated with the same domain.

4. The method of claim 3, further comprising, based on the template, generate structural information for a first type of web content.

5. The method of claim 4, further comprising build a knowledge graph from the structural information for the same domain.

6. The method of claim 5, wherein the knowledge graph comprises an ontology associated with the same domain.

7. The method of claim 6, wherein generating the template comprises generating a first template from the first annotated web document and a second template from the second annotated web document.

8. The method of claim 7, wherein generating the template further comprises ranking the first template over the second template.

9. The method of claim 8, wherein generating the template further comprises conflating the first template with the second template into a conflated template.

10. The method of claim 9, wherein the ontology is built from the conflated template.

11. A computer storage media having stored thereon computer-executable instructions that when executed by a processor causes the processor to perform a method, the method comprising:
executing an annotation template application for a web browser;
receiving a web document;
annotating an element in the web document with the annotation template application to create an annotated web document;
extracting metadata from the web document based on the annotated element in the web document; and
sending the annotated web document and the extracted metadata from the web document to an extraction service.

12. The computer storage media of claim 11, further comprising receiving the annotation template application from the extraction service.

13. The computer storage media of claim 11, wherein the annotation of the element is a visual indicia placed in the web document.

14. The computer storage media of claim 11, wherein the annotation of the element indicates a location of the element within the web document.

15. The computer storage media of claim 11, wherein the annotation of the element indicates a type of content associated with the element within the web document.

16. An extraction service server comprising:
a memory having stored thereon computer-executable instructions; and
a processor, in communication the memory, to execute the computer-executable instructions to perform a method comprising:
receiving, at a template service executed with the processor, a first annotated web document from a first client;
receiving, at the template service, a second annotated web document from a second client, wherein the first annotated web document and the second annotated web document are associated with similar content from a same domain;
based on the first annotated web document and the second annotated web document, generating a template indicating a structure of the annotated web document;
storing the template in a structural data repository;
based on the template, generate structural information for the similar content; and
build a knowledge graph from the structural information for the same domain.

17. The server of claim 16, wherein the first annotated web document annotates a structure for a web document.

18. The server of claim 16, wherein the knowledge graph comprises an ontology associated with the same domain.

19. The server of claim 16, wherein generating the template comprises generating a first template from the first annotated web document and a second template from the second annotated web document.

20. The server of claim 19, wherein generating the template further comprises:
ranking the first template over the second template; and
conflating the first template with the second template.
